(19) United States
(12) Patent Application Publication
(10) Pub. No.: US 2006/0109736 A1
(43) Pub. Date: May 25, 2006

(54) Device for mixing-dosing liquid cleaning product

(76) Inventor: Cecilio Antonio Neto, Sao Paulo (BR)

Correspondence Address: DICKINSON WRIGHT PLLC, 1901 L. STREET NW, SUITE 800, WASHINGTON, DC, 20036, US

(21) Appl. No.: 10/997,363

(22) Filed: Nov. 23, 2004

(51) Int. Cl. A21C 1/00

(52) U.S. Cl. 366/69

(57) ABSTRACT

A device for mixing-dosing liquid cleaning products with water or other carriers is disclosed. The device comprises a body with a cover, which is fixed and hermetically sealed to a flask containing a series of doses of liquid concentrated cleaning products diluted in the water in the act of use. A venturi is incorporated into the body with a cover and includes a water entry that receives a hose with the opposed end having easy coupling to a tap. An orthogonal hole is formed in the entry, with the hole opening in the interior of the flask and gauged to join the water flow with the appropriate quantity of the cleaning product. An exit is aligned to the entry and receives a dispenser hose of the cleaning solution already mixed

### FIELD OF THE INVENTION

The present invention relates to the mixing of liquid cleaning products. More particularly, the present invention relates to a mixing-dosing device applicable to the field of components of packages for liquid products, developed to facilitate the use thereof, especially in the case of concentrated cleaning products diluted in water, and in adequate proportion when in use.

### DESCRIPTION OF THE RELATED ART

Cleaning products for floors, walls, and surfaces in general are well-known in the art, as are products for odor control and for disinfection of specific areas, such as toilets and similar facilities. Regardless of the application, all of these cleaning products are constituted by a concentrated element and distributed to the consuming public in flasks. When in use, the concentrated cleanser is diluted in water preferably within a bucket or similar container. These products are mixed in the water in the appropriate proportion. If the solution obtained is weak, this results in a less effective cleaning. If the solution obtained is very strong, this results in an efficient but very aggressive cleaning and a consumption of more of the product than is necessary.

Therefore, the operation of dosing the product and mixing it in water shall observe a few criteria and shall substantially include the following stages: placement of the appropriate volume of water in the container in which the cleaning solution will be prepared; opening the flask containing the cleaning concentrate; emptying the cleaning concentrate in a dose controller; emptying the dosed concentrate in the water; and mixing the water-concentrate solution.

Despite the apparent simplicity of these procedures, correct use of the material is critical to the security of the operator, due to the level of toxicity of the product. This is particularly true where any direct contact and/or contact with its emanations may be harmful.

Thus, the technically correct handling of these products requires a series of steps, such as the use of a dose controller, the use of appropriate clothing by the operator (such as an apron, gloves, mask, and the like), care during the handling of the product, as well as other required steps.

As mentioned above, care during the handling shall normally involve well-defined and determined actions, such as selecting a location not accessible by unauthorized personnel, storage of the flasks of the cleaning concentrate in the secure location, preparing the cleaning solution in this location, transporting the solution in the appropriate container from this location to the location in which the cleaning will effectively occur, applying the cleaning solution in the location to be cleaned following the characteristics of the cleaning concentrate and the purposes to which it is destined, and refilling the container as needed until the cleaning task is completed. These steps avoid unauthorized personnel being in contact with the product.

All the steps related to the use of these products, as described above, will require minimum training to the operators, especially if hired by companies that specialize in the cleaning of large areas, such as offices, industries, hospitals, and others, or if simply referring to the personnel responsible for the cleaning of these areas.

Because of the use of time and personnel needed for proper training these circumstances obviously have negative impacts to the cost of the products and the operations of cleaning performed with such products.

### BRIEF SUMMARY OF THE INVENTION

Thus, the general object of the present invention is to provide an improvement over methods and equipment for mixing cleaning products and water as are previously known.

It is a first object of the mixing-dosing device for liquid cleaning products according to the present invention to provide means to allow the dosage and mixture of a liquid cleaning product directly in the dilution water, in a manner whereby the undiluted product will never be exposed and get in direct contact and/or in contact with its emanations by the operator, who shall have their physical integrity protected.

Another object of the present invention is to provide a tool that simplifies the handling of the liquid cleaning product, both in the procedures of dilution and in the application to the surfaces to be cleaned.

Another object of the present invention is to provide a device for the handling of the cleaning product that will not require the use of protective clothing and the necessity of specific training for the operator.

Another object of the present invention is to provide a way of handling that will allow the amplification of the field of use of the concentrated cleaning products, which are diluted in the area in the act of use.

Another object of the present invention is to allow a reduction in the cost of the product and in the cleaning process.

Another advantage of the present invention is that it is readily disposable due to its relatively low material and production costs.

In light of these and other objects and in order to overcome the problems listed, the device of the present invention for mixing-dosing liquid cleaning products or others, diluted in water (or other solutions) substantially comprises a body with a cover, which is fixed and hermetically sealed to a flask containing a series of doses of liquid concentrated cleaning products diluted in the water in the act of use. A venturi is incorporated into the body with a cover and includes a water entry that receives a hose with the opposed end having easy coupling to a tap. An orthogonal hole is formed in the entry, with the hole opening in the interior of the flask and gauged to join the water flow with the appropriate quantity of the cleaning product. An exit is aligned to the entry and receives a dispenser hose of the cleaning solution already mixed.

This form of construction of the device resolves the problems observed in the conventional manner of handling the concentrated cleaning products diluted in water in the act of the use, once, as verified above, the pure cleaning product will not be exposed in any moment during the procedures of dilution and application, therefore eliminating risks of direct contact and/or contact with its emanations by the operator.

This manner of handling of the cleaning product through the mixing-dosing device also simplifies the procedures of dilution if compared to the conventional methods, since it does not require the use of dose controllers, the necessity of opening the flask, pouring part of its content in the dose controller and from this to the bucket, nor the use of security clothing by the operator. On the other hand, this manner of handling of the cleaning product through the mixing-dosing device also simplifies the cleaning operation itself, since the flask with the cleaning product, hermetically sealed by the device, may be carried to the location where the cleaning will effectively occur and, if necessary, the device can be coupled to any tap in said area or in a nearby location, therefore avoiding the necessity of existence of an isolated location for the storage of the product and composition of the cleaning solution, the transportation from this location to the location of cleaning, and refills through transportation, as occurred in the conventional procedures described above.

This mixing-dosing device of concentrated cleaning products diluted in water in the act of use, as verified, allows extreme security and, as a result, does not require special training to the operator, further allowing the amplification of the field of use of the product. As a matter of fact, these cleaning products may also be destined to domestic use, since they can be operated by personnel without any specific training, following under the instructions in the flask, as occurred in various other types of products to all purposes.

The handling of cleaning products with the mixing-dosing device, as could not be different, has positive impacts in the final cost of the product and in the cleaning performed with them.

These and other objects are achieved by the invention set forth hereinafter.

### BRIEF DESCRIPTION OF THE DRAWINGS

The present invention will be more fully understood by reference to the following detailed description of the preferred embodiments of the present invention when read in conjunction with the accompanying drawings, in which like reference characters refer to like parts throughout the views, and in which:

FIG. 1 is a partially sectional view of the device of the present invention, illustrating how the device is applied to a flask of package of the product;

FIG. 2 is an elevated side view of the outside of the device of the present invention; and

FIG. 3 demonstrates the device in use.

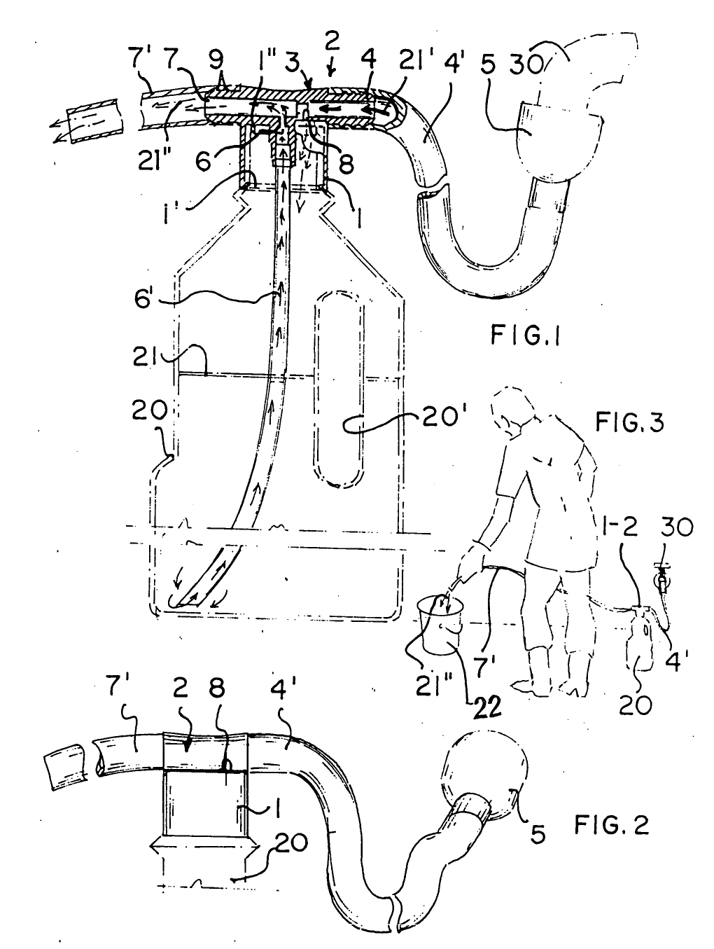

### DETAILED DESCRIPTION OF THE PREFERRED EMBODIMENTS

The drawings disclose the preferred embodiments of the present invention. While the configurations according to the illustrated embodiment are preferred, it is envisioned that alternate configurations of the present invention may be adopted without deviating from the invention as portrayed. The preferred embodiments are discussed hereafter.

Pursuant to the illustrations contained in the accompanying drawings, the object of the present patent of invention is to automatically mix and dose concentrated liquid products supplied to consumption and disposed in flasks, the products being diluted in water during use and destined for the cleaning and/or disinfection of various surfaces, such as floors, walls, doors, glasses, electrical and electronic devices, telephones, and others, and/or odor control of compartments such as toilets or similar facilities and/or others. The device of the present invention substantially comprises a body with a cover 1, which is fixed and hermetically sealed to a flask 20 containing a series of doses of liquid product for the cleaning/disinfection/odor control 21 of concentrated type and diluted in the water in the act of use. The device also comprises a venturi 2 substantially formed by a tubular element 3 incorporated into the body with cover 1 and comprising, in one of the ends, of a water entry 4 that receives the end of a hose 4′ with the opposed end having a terminal 5 with easy coupling to a tap 30. Intermediately, the tubular element 3 comprises a radial hole 6 that opens inwards the flask 20, receives a tube 6′ extended to its bottom, the hole being gauged to (through the venture) incorporate the water flow 21′ circulating in the tubular element 3 a flux of the cleaning fluid-water solution 21 at rate selected to allow the pertinent dilution of the product in the water. In the opposed end of the tubular element 3, which comprises the venturi 2, further includes an exit 7 that receives a hose 7′ whose opposed end releases the cleaning solution 21″ formed, composed of water and the cleaning product appropriately dosed, such as 1:20 or 1:400, or in some other proportion of dilution, according to the type of cleaning product and/or disinfection product and/or odor control product. The mixing-dosing device further comprises a finite tubular appendix 8 preferably extending from the face of top of the body with cover 1 originally sealed and broken in the beginning of the use of the product in order to define an air opening.

Thus, the mixing-dosing device aforementioned functions as follows. First, the appendix 8 is broken to define the opening for air entry. After that, the rapid coupling 5 of the hose of water entry 4′ is connected to a tap 30. The hose of the exit of the cleaning solution 7 is connected to a tube 7′ and the other end of the tube 6′ is placed into a container 22 in which the formed cleaning solution 21″ is stored. Finally, the tap 30 is open, through which the water 21′ starts to circulate through the hose of water entry 4, tubular element of venturi 3 and exit hose 7, considering that when it passes by the radial hose 6 of the tubular element 3 a depression is caused in the tube 6′ connected to the hole gauged 6—which creates in effect a venturi—that allows the flow of the product 21 at the appropriate rate defined by the gauged hole 6, mixing the water flow 21′ and forming the cleaning solution 21″, dispensed in the free end of the exit hose 7. Simultaneously, a constant air flow enters the space above the portion of product 21 within the flask 20, through the air opening of the appendix 8, in order to avoid the formation of vacuum and the interruption of the functioning of the device.

According to the aforementioned basic construction, the object of the present invention may present modifications related to materials, dimensions, constructive details and/or configuration details not within the scope of the protection desired.

In this context, the body with cover 1 may be a cylinder, as illustrated, or may have other configurations as deemed more suitable to the package set. The manner of fixation of the body with cover 1 to the flask 20 may be any adequate one that allows hermetic closing, as illustrated, and that comprises a lower internal groove 1′ and an upper internal circular rim 1″ in the lateral and upper walls of the body with cover 1, respectively, coupling to the re-entrance and mouth of flask 20, respectively.

The hole of the venturi 6 is gauged according to the characteristics and purposes of the product and its proportion of dilution in the water. Thus, the device can support products destined to light and heavy cleaning, removal of waxes and similar products, cleaning of surfaces in general, cleaning, disinfection, and odor control with dilution rates from 1:10 to 1:500, to which the hole is gauged according to each proportion of dilution. The hole 6 may be disposed in the bottom of a tubular projection 6″, extended from the internal surface of the top wall of the body with cover 1 and where the tube 6′ is coupled, extended to the bottom of the flask 20, as illustrated, or according to other solutions.

The ends of entry 4 and exit 7 are provided with grooves 9 or other means for attaching the hoses 4′ and 7′.

The flask 20 may have ornamental configurations and capacities adequate of any type and, preferably, a handle 20′.

The set comprising the mixing-dosing device and flask is preferably made of a polymerized material such as plastic and with constitutive and constructive characteristics adequate to be disposed after use.

The mixing-dosing device proposed herein may be also used to automatically mix and dose other liquid products not applied to cleaning purposes, as described, which also require any type of dilution or similar procedure in the use.

Those skilled in the art can now appreciate from the foregoing description that the broad teachings of the present invention can be implemented in a variety of forms. Therefore, while this invention has been described in connection with particular examples thereof, the true scope of the invention should not be so limited since other modifications will become apparent to the skilled practitioner upon a study of the drawings, specification and the following claims.

What is claimed is:

1. A mixing-dosing device for the mixing and dosing of a cleaning solute with a solvent, the device comprising:
a mixing flask having an opening;
a mixing-dosing assembly including a body and a cover, said cover being removably attachable to said mixing flask at said opening, said cover having a venturi substantially formed by a tubular element in which the mixing of said solute and said solvent substantially occurs incorporated within said body, said tubular element having a first end and a second end, said first end of said tubular element being fitted with solvent entry, said tubular element further having defined therein a radial hole, said radial hole being opened inwardly toward said mixing flask, said radial hole having an inner dimension, said inner dimension being gauged to regulate the flow of solute so as to achieve the correct proportion of solute to solvent, said assembly further including a tube, said tube being disposed through said radial hole and into said mixing flask, said second end of said tubular element including an exit through which the solute-solvent solution flows, said cover having an openable air entry formed therein.

2. The mixing-dosing device of claim 1 further including a hose having a first end and a second end, said first end of said hose being attached to said solvent entry of said first end of said tubular element and said second end of said hose having a terminal for coupling with a solvent source.

3. The mixing-dosing device of claim 1 further including a tube connected to said exit of said second end of tubular element.

4. The mixing-dosing device of claim 1 in which said openable air entry of said cover is closed prior to use of said device and is opened to allow use of said device.

5. The mixing-dosing device of claim 1 wherein said flask is formed from a polyermized material.

6. The mixing-dosing device of claim 1 wherein said radial hole is formed within a receptacle, said receptacle being formed substantially perpendicularly with respect to said tubular element.

7. A mixing-dosing device for the mixing and dosing of a cleaning solute with a solvent, the device comprising:
a mixing flask having an opening;
a mixing-dosing assembly including a body and a cover, said cover being removably attachable to said mixing flask at said opening, said cover having a venturi substantially formed by a tubular element incorporated within said body, said tubular element having a first end and a second end, said first end of said tubular element being fitted with solvent entry, said tubular element further having defined therein a radial hole, said radial hole being opened inwardly toward said mixing flask, said assembly further including a tube, said tube being disposed through said radial hole and into said mixing flask, said second end of said tubular element including an exit through which the solute-solvent solution flows, said cover having an openable air entry formed therein.

8. The mixing-dosing device of claim 7 further including a hose having a first end and a second end, said first end of said hose being attached to said solvent entry of said first end of said tubular element and said second end of said hose having a terminal for coupling with a solvent source.

9. The mixing-dosing device of claim 7 further including a tube connected to said exit of said second end of tubular element.

10. The mixing-dosing device of claim 7 in which said openable air entry of said cover is closed prior to use of said device and is opened to allow use of said device.

11. The mixing-dosing device of claim 7 wherein said radial hole has an inner dimension, said inner dimension being gauged to regulate the flow of solute so as to achieve the correct proportion of solute to solvent.

12. The mixing-dosing device of claim 7 wherein said flask is formed from a polyermized material.

13. The mixing-dosing device of claim 7 wherein the mixing of said solute and said solvent substantially occurs in said tubular element.

14. The mixing-dosing device of claim 7 wherein said radial hole is formed within a receptacle, said receptacle being formed substantially perpendicularly with respect to said tubular element.

15. The mixing-dosing device of claim 7 wherein said tubular element and said cover are formed from chemical-resistant material.

16. A mixing-dosing device for the mixing and dosing of a cleaning solute with a solvent, the device comprising:
a mixing flask having an opening;
a mixing-dosing assembly including a body and a cover, said cover being removably attachable to said mixing flask at said opening, said cover having a venturi substantially formed by a tubular element incorporated within said body, said tubular element having a first end and a second end, said first end of said tubular element being fitted with solvent entry, said tubular element further having defined therein a radial hole, said radial hole being opened inwardly toward said mixing flask, said radial hole having an inner dimension, said inner dimension being gauged to regulate the flow of solute so as to achieve the correct proportion of solute to solvent, said assembly further including a tube, said tube being disposed through said radial hole and into said mixing flask, said second end of said tubular element including an exit through which the solute-solvent solution flows, said cover having an openable air entry formed therein.

17. The mixing-dosing device of claim 16 further including a hose having a first end and a second end, said first end of said hose being attached to said solvent entry of said first end of said tubular element and said second end of said hose having a terminal for coupling with a solvent source.

18. The mixing-dosing device of claim 16 further including a tube connected to said exit of said second end of tubular element.

19. The mixing-dosing device of claim 16 in which said openable air entry of said cover is closed prior to use of said device and is opened to allow use of said device.

20. The mixing-dosing device of claim 16 wherein the mixing of said solute and said solvent substantially occurs in said tubular element.
